(19) United States
(12) Patent Application Publication
(10) Pub. No.: US 2007/0085885 A1
(43) Pub. Date: Apr. 19, 2007

(54) Liquid-Droplet Ejecting Apparatus

(75) Inventors: Atsushi Ito, Nagoya-shi (JP); Hiromitsu Mizutani, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/470,431

(22) Filed: Sep. 6, 2006

(30) Foreign Application Priority Data
Sep. 6, 2005 (JP) 2005-258075

(51) Int. Cl. B41J 2/175

(52) U.S. Cl. 347/93

(57) ABSTRACT

There is disclosed a liquid-droplet ejecting apparatus including a cavity unit, a supply-passage forming portion, and a filter member. The cavity unit has nozzle groups each of which includes at least one nozzle from which a droplet of a liquid is ejected. At least two of the nozzle groups are differentiated from each other in the cross-sectional area of the nozzles. The supply-passage forming portion integrally includes liquid supply passages that correspond to the respective nozzle groups, and are open in a same surface of the supply-passage forming portion. The filter member integrally includes filtering portions, and is closely attached to the surface of the supply-passage forming portion such that the filtering portions respectively cover openings of the passages. Each filtering portion has pores of a cross-sectional area such that a cross-sectional area of pores in one of the filtering portions, which corresponds to a first one of the at least two nozzle groups a cross-sectional area of the nozzle belonging to which is larger than that of the nozzle belonging to a second one of the at least two nozzle groups, is larger than a cross-sectional area of pores of another filtering portion corresponding to the second nozzle group.

### INCORPORATION BY REFERENCE

The present application is based on Japanese Patent Application No. 2005-258075, filed on Sep. 6, 2005, the contents of which are incorporated herein by reference.

### BACKGROUND OF THE INVENTION

1. Field of the Invention

The present invention relates to a liquid-droplet ejecting apparatus having a plurality of nozzles from each of which a droplet of a liquid such as ink is ejected.

2. Description of Related Art

As a liquid-droplet ejecting apparatus having a plurality of nozzles from each of which a droplet of a liquid is ejected, there is an inkjet printhead having a plurality of nozzles from each of which a small droplet of an ink is ejected with high precision and accuracy. When a nozzle in the inkjet printhead is clogged with a foreign particle, an ink droplet is not ejected in an excellent manner, or completely fails to be ejected, from that nozzle, resulting in poor quality of an image recorded using the inkjet printhead. To prevent this, it is known to provide, in an ink supply passage extending into the inkjet printhead from the exterior of the inkjet printhead, such as an ink container, a filter member including a filtering portion in which a large number of through-holes or pores are formed, as disclosed in JP-A-11-291514 (see FIGS. 1 and 7), for instance. On the way to the nozzle from the exterior, the ink is passed through the filtering portion (or the through-holes or pores formed therein) in order to eliminate foreign particles contained in the ink, if any, to supply an ink containing no foreign particles to the nozzle.

Meanwhile, with the recent trend to make inkjet printers capable of color printing, an inkjet printhead recently produced is constructed to eject a droplet of a plurality of inks of respective colors, and thus has a plurality of ink supply passages corresponding to the respective color inks.

Inclusion of a plurality of ink supply passages necessitates inclusion of a corresponding plurality of filtering portions in the filter member. During production of the inkjet printhead, a plurality of filter members may be attached with respect to a respective plurality of ink supply passages such that one filter member is attached with respect to each of the ink supply passages. However, the ink supply passages are so narrow or fine that attaching one filter member for each ink supply passage is very difficult in actual production. As a way to simplify the attaching of the filter member, the present inventor(s) has thought up to produce the inkjet printhead such that a single integral filter member including a plurality of filtering portions is first prepared, and then the single filter member is attached with respect to the plurality of ink supply passages.

Due to its function to eliminate a foreign particle, the pores in each filtering portion should have a cross-sectional area smaller than that of the corresponding nozzle. When the cross-sectional area of the pores is made extremely small as compared to that of the nozzle, the effect of eliminating a foreign particle is enhanced to reliably prevent clogging of the nozzle. However, decrease in the cross-sectional area of each of the pores in one filtering portion decreases a total cross-sectional area of the pores in the filtering portion, thereby making too high a resistance of the ink supply passage, in which the filtering portion is disposed, to flow of the ink at the filtering portion, and also causing clogging of the pores with a foreign particle. This results in an insufficient amount of ink supplied to the nozzle.

In an inkjet printhead for ejecting a droplet of a plurality of inks of respective colors, a plurality of nozzle groups are provided for the respective color inks, and at least two of the nozzle groups are differentiated from each other in the cross-sectional area of the nozzles. Where a single integral filter member including a plurality of filtering portions is attached such that the filtering portions correspond to a respective plurality of ink supply passages for the color inks, it is requested to optimize the cross-sectional area of the pores, filtering-portion by filtering-portion, depending on the cross-sectional area of the corresponding one of the nozzle groups, in order to prevent problems including the shortage in the ink supply and the clogging at the nozzle or the filtering portion. It is noted that where the pores of a filtering portion are circular in plan view, the cross-sectional area of the pores increases and decreases with increase and decrease in a diameter of the pores. Similarly, where the nozzles are circular in plan view, the cross-sectional area thereof increases and decreases with increase and decrease in a diameter of the nozzles.

Where the cross-sectional area of the pores is differentiated among the filtering portions depending on the cross-sectional area of the nozzles of the corresponding nozzle groups, as described above, attachment of the filter member is usually implemented such that filtering portions (or a single filtering portion) the pores of which have a same cross-sectional area are (is) grouped so that the filtering portion(s) of a group are (is) simultaneously formed, and then the filter member where all the groups of filtering portion(s) are finished is attached with respect to the ink supply passages. This production method involves many steps and can not ensure a uniform, desired quality of inkjet printheads produced thereby.

### SUMMARY OF THE INVENTION

This invention has been developed in view of the above-described situations, and it is an object of the invention to provide a liquid-droplet ejecting apparatus including a plurality of nozzle groups at least two of which are different from each other in the cross-sectional area of the nozzles, where no nozzles suffer from clogging or shortage in liquid supply, and which ensures desired ejection characteristics.

To attain the above object, the invention provides a liquid-droplet ejecting apparatus including: a cavity unit having a plurality of nozzle groups each of which includes at least one nozzle from which a droplet of a liquid is ejected, at least two of the nozzle groups being differentiated from each other in the cross-sectional area of the nozzles; a supply-passage forming portion which integrally includes a plurality of liquid supply passages corresponding to the respective nozzle groups, the liquid supply passages being open in a same surface of the supply-passage forming portion; a filter member which integrally includes a plurality of filtering portions and is closely attached to the surface of the supply-passage forming portion such that the filtering portions respectively cover openings of the liquid supply passages, each of the filtering portions having a plurality of pores of a cross-sectional area such that a cross-sectional area of pores in one of the filtering portions, which corresponds to a first one of the at least two nozzle groups a cross-sectional area of the nozzle belonging to which is larger than that of the nozzle belonging to a second one of the at least two nozzle groups, is larger than a cross-sectional area of pores of another filtering portion corresponding to the second nozzle group.

According to the liquid-droplet ejecting apparatus, at least a part of the nozzle groups formed in the same cavity unit are different from one another in the cross-sectional area of the nozzles. The cross-sectional area of pores of a filtering portion corresponding to a nozzle group, the cross-sectional area of the nozzle belonging to which is relatively large, is made relatively large, and the cross-sectional area of pores of another filtering portion corresponding another nozzle group, the cross-sectional area of the nozzle belonging to which is relatively small, is made relatively small. In a case where the pores of all the filtering portions have a same cross-sectional area that is suitable for a nozzle group where the nozzle has a large cross-sectional area, the nozzle belonging to a nozzle group where the nozzle has a small cross-sectional area may be clogged with a foreign particle. On the other hand, where the pores of all the filtering portions have a same cross-sectional area that is suitable for a nozzle group where the nozzle has a small cross-sectional area, a resistance of a liquid supply passage corresponding to the nozzle group of the large cross-sectional area, to flow of the liquid, may be too high at the filtering portion to cause shortage in liquid supply to the nozzle. However, the apparatus of the invention prevents such problems, and all the nozzles are free from clogging or shortage in liquid supply. Thus, desired ejection characteristics of the liquid-droplet ejecting apparatus can be ensured.

Since a plurality of filtering portions, each having a plurality of pores, are integrally formed in the filter member, or a plurality of filtering portions are formed in a single integral filter member, the filtering portions can be at once disposed relative to the liquid supply passages, by simply attaching the filter member to the surface of the supply-passage forming portion in which the liquid supply passages open, or in which the openings of the liquid supply passages are arranged. As compared to a case where one filter member is attached relative to each of liquid supply passages, that is, where discrete filter members are attached relative to respective liquid supply passages, attachment of the filter member with respect to the liquid supply passages is considerably easy in the present invention. Further, the position of the filtering portions relative to the openings of the liquid supply passages is made uniform among liquid-droplet ejecting apparatuses as products, thereby making the quality or performance of the apparatuses uniform.

### BRIEF DESCRIPTION OF THE DRAWINGS

The above and other objects, features, advantages and technical and industrial significance of the present invention will be better understood by reading the following detailed description of preferred embodiments of the invention, when considered in connection with the accompanying drawings, in which:

FIG. 1 is an exploded perspective view of an inkjet printhead according to one embodiment of the invention;

FIG. 2 is an exploded perspective view of a cavity unit of the inkjet printhead;

FIG. 3 is a fragmentary exploded perspective view of the cavity unit;

FIG. 4A is a plan view of a filter member attached to the cavity unit, and FIG. 4B is a cross-sectional view along line 4B-4B in FIG. 4A and shows the filter member as formed by electroforming on a base form and before separated therefrom; and

FIG. 5A is a cross-sectional view taken along line 5A-5A in FIG. 4A, and FIG. 5B is an explanatory view showing a cross-sectional shape of nozzles in the inkjet printhead.

### DETAILED DESCRIPTION OF PREFERRED EMBODIMENTS

Hereinafter, there will be described one preferred embodiment of the invention, by referring to the accompanying drawings.

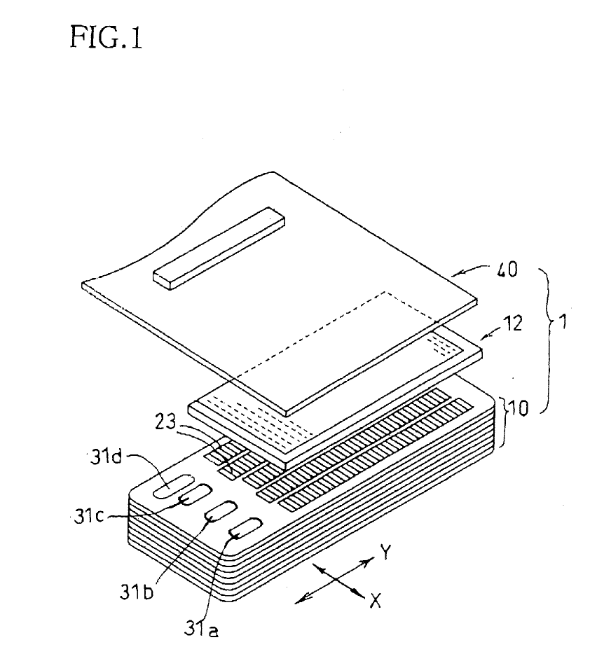

In the present embodiment, a liquid-droplet ejecting apparatus of the invention takes the form of an inkjet printhead. Referring to FIG. 1, reference numeral 1 generally denotes the inkjet printhead. The inkjet printhead 1 is included in a head unit (not shown) that is supported by a carriage (not shown) reciprocated in a main scanning direction (i.e., a direction X) perpendicular to an auxiliary scanning direction or a medium feeding direction (i.e., a direction Y) in which a recording medium is fed. To the inkjet printhead 1 of the head unit, four inks of respective colors, e.g., cyan, magenta, yellow and black, are supplied. The inks are supplied to the inkjet printhead 1 such that ink cartridges filled with the respective inks are (i) detachably attached to the head unit, or alternatively (ii) fixed in position in a mainbody (not shown) of an image forming apparatus in which the head unit is disposed, so that the inks are supplied from the ink cartridges into the head unit via supply tubes (not shown).

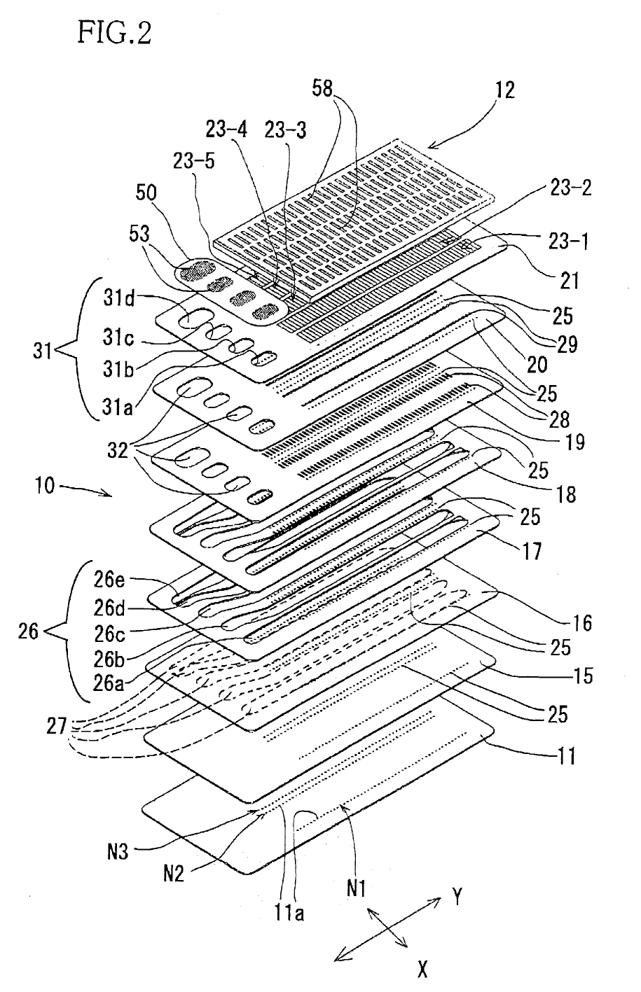

As shown in FIG. 1, the inkjet printhead 1 includes a cavity unit 10, a planar piezoelectric actuator unit 12 and a flexible flat cable 40. In a front surface of the cavity unit 10, i.e., a lower surface thereof as seen in FIG. 1, a plurality of nozzles 11a (shown in FIG. 2) are arranged in a plurality of rows N. The planar piezoelectric actuator unit 12 is bonded to an upper surface of the cavity unit 10, with an adhesive agent or an adhesive sheet. The flexible flat cable 40 is superposed on and bonded to a back or an upper surface of the piezoelectric actuator unit 12, for electrical connection with an external device.

As shown in FIG. 2, the cavity unit 10 is formed of eight thin flat plates stacked and bonded one on another with an adhesive agent. The eight plates are a nozzle plate 11, a spacer plate 15, a damper plate 16, two manifold plates 17, 18, a supply plate 19, a base plate 20 and a cavity plate 21, from bottom up. Except the nozzle plate 11 that is made of synthetic resin, each plate 15-21 is made of a nickel alloy steel sheet containing 42% of nickel and has a thickness of about 50-150 μm.

More specifically, the nozzle plate 11 is made of polyimide, and having a large number of through-holes as nozzles 11a for ejecting droplets of the inks therefrom. As described later, each nozzle 11a has a very small cross-sectional area. The cross-sectional area of the nozzle 11a increases and decreases with increase and decrease in a diameter of the nozzle 11a, since the nozzle 11a is circular in plan view in this embodiment. The nozzles 11a are arranged in five rows N each extending along longer sides of the nozzle plate 11, i.e., in the direction Y or auxiliary scanning direction. In this specific example, the nozzle plate 11 is formed by irradiating a polyimide sheet with excimer laser to make through-holes as the nozzles 11a. The nozzles 11a are divided into four groups, each of which is for ejecting droplets of a same color ink. Each group of nozzles 11a is arranged in one nozzle row N except the nozzle group for the black ink.

That is, among five nozzle rows N, which are respectively denoted by reference symbols N1-N5 from right to left as seen in FIG. 2 (although nozzle rows N4 and N5 are not shown), and arranged along the shorter sides of the nozzle plate 11 (i.e., in the direction X or main scanning direction) at suitable intervals, the nozzle rows N4 and N5 are of the nozzle group for ejecting the black ink. The nozzle row N1 is of the nozzle group for ejecting the cyan ink (C), the nozzle row N2 is of the nozzle group for ejecting the yellow ink (Y), and the nozzle row N3 is of the nozzle row for ejecting the magenta ink (M).

It is often the case that the diameter is uniform among all the nozzle groups, irrespective of the colors of the inks to be ejected. However, in this embodiment, the diameter of the nozzles 11a for ejecting the black ink is made larger than that of the nozzles 11a for ejecting the inks of the other colors, i.e., the cyan, magenta and yellow inks. More specifically, the diameter of the nozzles 11a for the black ink is 20.5 μm, and that of the nozzles 11a for the other color inks is 18.0 μm. This is because the color inks other than the black ink are mainly used to record a photographic image, and it is required to eject the color inks as extremely fine droplets. On the other hand, the black ink is mainly used to record text such as letters and characters, and it is required to eject the black ink in a relatively large size and at a high speed.

In the cavity plate 21, there are formed through-holes as pressure chambers 23. The pressure chambers 23 are arranged in rows, which are denoted by reference numerals 23-1, 23-2, 23-3, 23-4 and 23-5, and correspond to the nozzle rows N1-N5, respectively. Each pressure chamber 23 is long in the direction X. Each row 23-1, 23-2, 23-3, 23-4, 23-5 of the pressure chambers 23 includes a number of pressure chambers 23 corresponding to the number of the nozzles 11a included in the corresponding nozzle row N. The pressure chambers 23 of a row are arranged along the direction Y, and each two pressure chambers 23 adjacent in the same direction is separated from each other with a separating wall 24.

Five ink channel chambers elongate in the direction Y are formed through the thickness of the upper and lower manifold plates 17, 18, to positionally correspond to the nozzle rows N1-N5. As the two manifold plates 17, 18 are sandwiched between the supply plate 19 on the upper side thereof and the damper plate 16 on the lower side, the ink channel chambers serve as five common ink chambers 26 or manifold chambers. As seen in FIG. 2, the common ink chambers 26 are denoted by reference symbols 26a, 26b, 26c, 26d and 26e. The common ink chamber 26a is for the cyan ink (C), the common ink chamber 26b is for the yellow ink (Y), the common ink chamber 26c is for the magenta ink (M), and the fourth and fifth common ink chambers 26d, 26e are for the black ink (BK). The common ink chambers 26a-26e respectively correspond to the rows of the pressure chambers 23 and extend therealong.

As shown in FIG. 2, four supply ports, which are denoted by reference symbols 31a, 31b, 31c and 31d from right to left, are formed through the cavity plate 21 at an end thereof in the direction Y. The supply ports 31a-31d are arranged along the direction X at suitable intervals, and correspond to openings of liquid supply passages. The supply ports 31a, 31b and 31c respectively correspond to the right-side three 26a, 26b, 26c of the common ink chambers, and the rest 31d of the supply ports, which is a fourth one as counted from right, corresponds to two common ink chambers 26d and 26e. More specifically, end portions of the common ink chambers 26d and 26e that are disposed close to each other positionally correspond to the supply port 31d. An opening area of the supply port 31d is accordingly larger than that of the other supply ports 31a-31c. In a longitudinal end portion of the base plate 20 and the supply plate 19, through-holes 32, which are to constitute a part of ink supply passages, are formed at positions corresponding to the supply ports 31a-31d, and are in communication with end portions of the common ink chambers 26 at the side corresponding to the supply ports 31.

On an upper surface of the cavity plate 21, a filter member 50 is attached so as to cover all of the four supply ports 31a-31d, as shown in FIG. 2. The filter member 50 will be fully described later.

On an under surface of the damper plate 16 that is bonded to an under surface of the lower manifold plate 17, there are formed recesses at positions corresponding to the common ink chambers 26. Each recess is open downward and long in the direction Y When the damper plate 16 is superposed on the space plate 15, the recesses are closed by the spacer plate 15 to form completely closed damper chambers 27.

When a pressure wave is produced in one of the pressure chambers 23 upon the piezoelectric actuator unit 12 is driven, a part of the pressure wave is propagated through the ink back toward the corresponding common ink chamber 26. This backward component of the pressure wave is absorbed by vibration of a ceiling portion of the damper chamber 27, which is a thinner portion of the damper plate 16, thereby preventing occurrence of crosstalk.

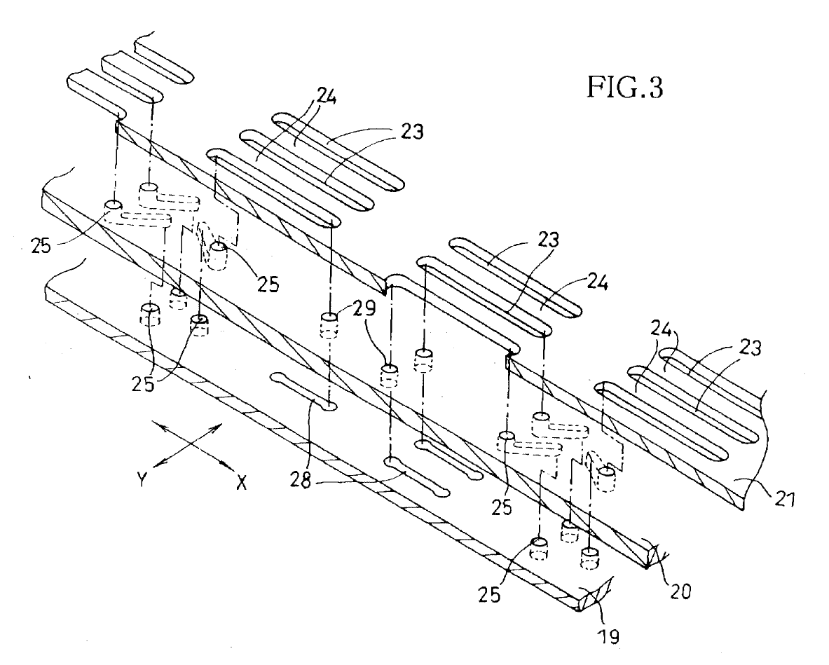

In the supply plate 19, elongate slit-like restricting portions 28 are formed to correspond to the pressure chambers 23. That is, an end of each restricting portion 28 communicates with a corresponding one of the common ink chambers 26a-26e formed in the manifold plate 18, and the other end of the restricting portion 28 is communicated with one end of a corresponding one of the pressure chambers 23 via a communication hole 29 that is shown in FIG. 3 and vertically extends through the base plate 20 that is disposed on the upper side of the supply plate 19.

The other end of the pressure chamber 23 is communicated with a corresponding one of the nozzles 11a in one of the nozzle rows N1-N5 via a communication passage 25 that vertically extends through the spacer plate 15, the damper plate 16, the two manifold plates 17, 18, the supply plate 19, and the base plate 20.

As described above, ink passages are formed by the series of the through-holes and the like formed in the plates 15-21, so that the inks introduced into the common ink chambers 26 through the supply ports 31a-31d pass through the restricting portions 28 and the communication holes 29 to be distributed to the pressure chambers 23 and then reach the nozzles 11a corresponding to the pressure chambers 23 via the communication passages 25.

The piezoelectric actuator unit 12 is similar to an actuator unit disclosed in JP-A-4-341853, for instance. That is, the piezoelectric actuator unit 12 is formed of a laminate of a plurality of piezoelectric sheets, each of which has a thickness of about 30 μm, and which are stacked to be partially sandwiched between elongate individual electrodes and common electrodes. The individual electrodes are disposed at positions corresponding to the pressure chambers 23 formed in the cavity unit 10, and each of the common electrodes is disposed to commonly correspond to a plurality of the pressure chambers 23. As shown in FIG. 2, on an upper surface of a topmost one of the piezoelectric sheets are disposed surface electrodes 58 for electrically connecting the individual electrodes and the common electrodes to the flexible flat cable 40. As well known in the art, a high voltage is applied between the individual electrodes of a desired position and the common electrodes, a part of the piezoelectric sheets positioned between the individual and common electrodes is polarized to operate as an active portion.

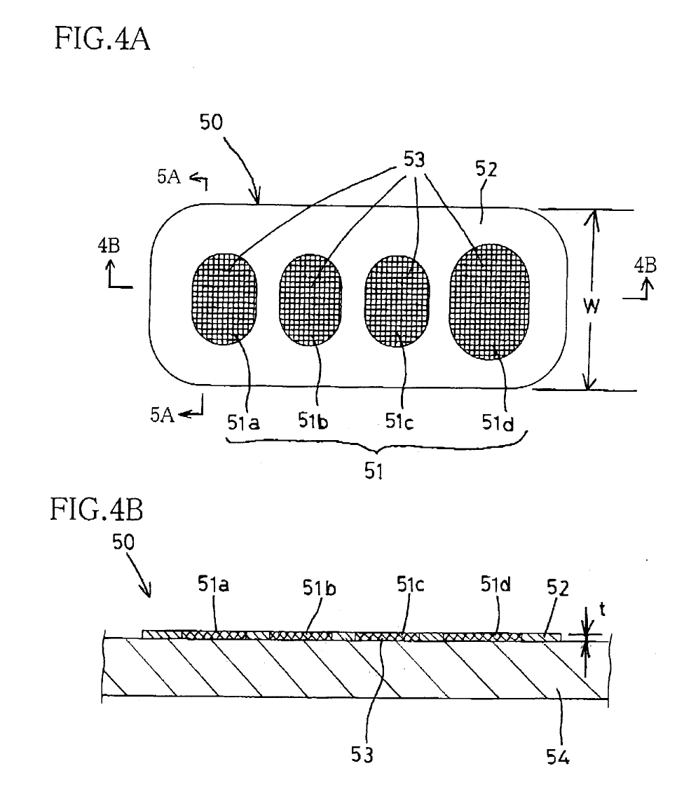

There will be now described the filter member 50. The filter member 50 has filtering portions 51 in each of which a large number of pores 53 or fine through-holes are formed through the thickness of the filter member 50, as shown in FIG. 4A. The filtering portions 51 are formed at positions corresponding to the opening areas of the supply ports 31. Since there are four supply ports 31 arranged in a row, four filtering portions 51 are formed and arranged in a row in the filter member 50. In plan view, the filter member 50 has a generally rectangular shape long in the direction along which the filtering portions 51 are arranged. More specifically, there are disposed four filtering portions 51a, 51b, 51c and 51d, that are for the cyan ink, the yellow ink, the magenta ink, and the black ink, respectively. The filtering portion 51d is larger in plan view than the other filtering portions 51a-51c, corresponding to the opening area of the supply port 31d that is larger than that of the other supply ports 31a-31c.

The filter member 50 includes a plate-like frame 52 that is substantially imperforate or substantially does not have a pore. The frame 52 defines therein the four filtering portions 51a-51d such that each adjacent two of the filtering portions 51a-51d arranged in a row are separated from each other by a part of the frame 52. Thus, it can be said that the frame 52 integrally connects the four filtering portions 51. Further, the filter member 50 is bonded to the frame 52 of the cavity unit 10, that is, an adhesive agent or the like is applied on the frame 52 of the filter member 50, and then the filter member 50 is superposed on the cavity unit 10 to bond the filter member 50 thereto. Two of the ink supply passages in which two adjacent filtering portions 51 are disposed are separated from, or not in communication with, each other by the bonding of the part of the frame 52 between the two adjacent filtering portions 51 to the cavity unit 10. Hence, the inks passing through the filtering portions 51 are prevented from flowing or spreading in the direction of the row of the filtering portions 51, and do not mix with one another.

The filter member 50 is formed of a metal by electroforming. As shown in FIG. 4B, according to electroforming, an insulating film is first formed on a base form 54 in a pattern of protrusions corresponding to the pores 53 of the filtering portions 51. Then, at portions on the base form 54 where the insulating film is not formed, a metal is deposited to form a metal film in a desired thickness, which corresponds to a thickness of the filter member 50. Then, the insulating film is removed, and the metal film is peeled or separated from the base form 54. The thus obtained metal film is used as the filter member 50. By forming the filter member 50 by electroforming, the filtering portions 51 and the frame 52 can be formed integrally at once.

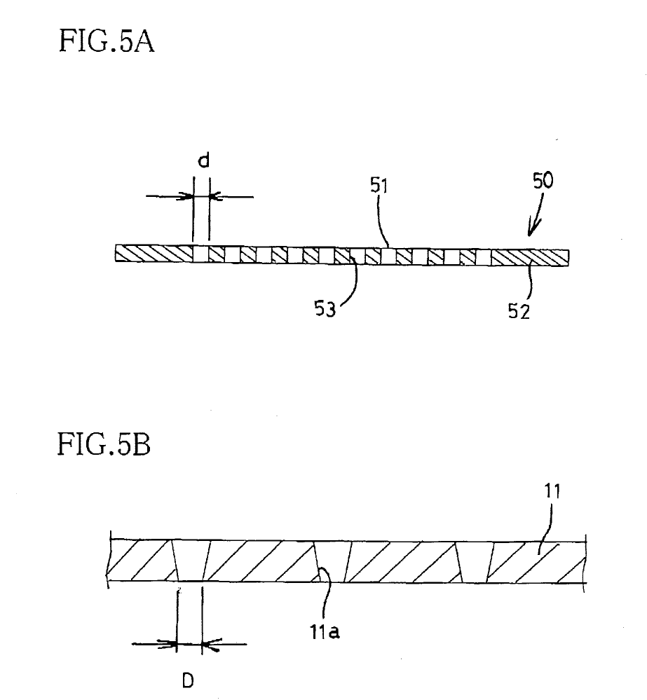

The pores 53 of the filtering portions 51 are circular in plan view. Cross-sectional areas of the pores 53 in the respective filtering portions 51 are determined depending on the cross-sectional areas or diameters of the nozzles 11a of the nozzle groups. Since the pores 53 are circular in plan view, the cross-sectional area of the pores 53 of each filtering portion increases and decreases with increase and decrease in a diameter of the pores 53, similar to the nozzles 11a. When the nozzles 11a are tapered as shown in FIG. 5B, an inner diameter of the nozzles 11a at their narrowest position is considered the diameter of the nozzles 11a. As mentioned above, the diameter of the nozzles 11a of the nozzle group for the black ink is set larger than the diameter of the nozzles 11a of the nozzle group for the yellow, magenta, and cyan inks. Hence, the diameter of the pores of the filtering portion 51d for the black ink is made larger than that of the pores of the filtering portions 51a-51c for the cyan, yellow and magenta inks. More specifically, where a nominal value of a “nozzle diameter” which refers to a diameter of nozzles 11a belonging to a particular one of the nozzle groups and a nominal value of “pore diameter” which refers to a diameter of pores in one of the filtering portions 51 corresponding to the particular nozzle group are respectively represented by D and d, an actual value of the nozzle diameter is expressed by D±α, in view of the dimensional accuracy of the nozzles 11a, an actual value of the pore diameter is expressed by d±β, in view of the dimensional accuracy of the pores 53 of the filtering portions 51, and a maximum diameter of foreign particles capable of passing through the pores 53 in the filtering portion 51 is expressed by d+γ. Hence, the nominal value d of the pore diameter is determined relative to the nozzle diameter to satisfy the following expression:
D−(α+β+γ)≧d (1)

That is, α represents a tolerance of the nozzle diameter and β represents a tolerance of the pore diameter, and a maximum diameter of foreign particles capable of passing through the pores 53 of the filtering portions 51 is expressed by (d+β+γ). The nominal nozzle diameter D and the nominal pore diameter d are determined in order that when the actual nozzle diameter takes a minimum value (D−α), a foreign particle of the maximum diameter can be ejected through the nozzles 11a without being caught thereat.

In this specific example, the nozzles 11a are formed by irradiating the nozzle plate 11 with excimer laser, as described above. In view of the dimensional accuracy of the nozzles 11a formed by such a method, the actual diameter of the nozzles 11a, which are formed in a circular shape in plan view, becomes D±3.5 μm, i.e., α=3.5, statistically. On the other hand, the pores 53 are formed by electroforming as described above. In view of the dimensional accuracy of the pores 53 formed by such a method, the actual pore diameter becomes d±2.0 μm, i.e., β=2.0, statistically. It is empirically known that when a sucking pressure is applied to the ink during a purging operation, the filtering portions 51 or the filter member 50 may warp or deform to allow a foreign particle having a diameter larger than the nominal pore diameter d to pass through a pore 53 of the filtering portions 51. A maximum diameter of foreign particles allowed to pass through the pores 53 in this way is d+1.0 μm, i.e., γ=1.0. Where the variables α, β, γ in the expression (1) are substituted by the specific values indicated above, the following relationship can be obtained between the nominal nozzle diameter D and the nominal pore diameter d: D−6.5 (μm)≧d.

Since in this specific example the nominal nozzle diameter D of the nozzle group for the black ink is 20.5 μm, as mentioned above, the nominal pore diameter d of the filtering portion 51d for the black ink is 14.0 μm or less. Similarly, since the nominal nozzle diameters D of the nozzle groups for the other inks, i.e., the cyan, yellow and magenta inks, are 18.0 μm, the nominal pore diameters d of the filtering portions 51a-51c for these inks are 11.5 μm or less.

The dimensional accuracies of the nozzles 11a and the pores 53, or the values of α, β, change depending on the methods according to which the nozzles 11a and the pores 53 are respectively formed. Hence, where the nominal nozzle diameter D is constant, the nominal pore diameter d changes with change in the methods. For instance, when the nozzles 11a are formed in the nozzle plate 11 by LIGA (LIthographie Galvanoformung und Abformung), which can ensure high dimensional accuracy of the formed nozzles 11a, the dimensional accuracy or tolerance α is enhanced up to a level of ±0.5 μm. Where the dimensional accuracy of the filter member 50 is enhanced, by scaling down or miniaturizing the base form 54 used in the electroforming process, for instance, the dimensional accuracy or tolerance β is enhanced up to a level of ±1.5 μm. Thus, when these methods are employed to enhance the dimensional accuracies of the nozzles 11a and the pores 53, the following relationship is obtained from the relational expression (1) between the nominal nozzle diameter D and the nominal pore diameter d: D−3.0 (μm)≧d.

In the case where these methods are employed, the nominal pore diameter d of the filtering portion 51d for the black ink is 17.5 μm, and that d of the filtering portions 51a-51c for the other inks, i.e., the cyan, yellow and magenta inks, is 15.0 μm, from the nominal nozzle diameters D of the respectively corresponding nozzle groups as described above.

As mentioned above, the relational expression (1) between the nominal nozzle diameter D and the nominal pore diameter d is derived from the dimensional accuracies α, β of the nozzles 11a and the pores 53, and the maximum diameter of foreign particles passable through the pores 53. The dimensional accuracies α, β are changed according to the methods of forming the nozzles 11a and the pores 53, respectively. Hence, the relational expression (1) is easily adaptable to change in the method of forming the nozzles 11a or the pores 53.

To prevent shortage in ink supply, it is desired not only to determine the nominal pore diameter d of a filtering portion 51 depending on the nominal nozzle diameter D of the corresponding nozzle group, but also to determine the number of pores 53 in each filtering portion 51 depending on the number of the nozzles 11a belonging to a nozzle group to which the filtering portion 51 corresponds.

Thus, the present applicant conducted a study to optimize the number of pores 53 in the filtering portion 51d for the black ink depending on the number of nozzles 11a of the nozzle group corresponding to the filtering portion 51d. In the study, the applicant carried out an experiment where droplets of the ink having passed through the filtering portion 51d for the black ink were kept ejected from the nozzles 11a of the nozzle group for the black ink, for a period equal to the service life of the inkjet printhead 1 as a product. In the experiment, the number N of the nozzles 11a of the nozzle group for the black ink was 148, and the number n of pores 53 in the filtering portion 51d was 20170. Thus, the number of pores 53 per nozzle, i.e., n/N, was 20170/74=136. The result of the experiment was such that 41 out of 136 pores of the filtering portion 51d were clogged with foreign particles. That is, about 30% of all the pores 53 were clogged.

There was also carried out another experiment to check whether ink supply to the nozzles 11a of the nozzle group for the black ink was sufficient in each of the cases where an open ratio took respective values. The term “open ratio” refers to a ratio of non-closed pores 53, which are pores not clogged, to all the pores 53 per nozzle, i.e., 136 (=n/N). The result of this experiment revealed that when 68 out of all, that is, 136, of the pores 53 per nozzle were open, a sufficient amount of ink could be supplied, without deteriorating the ejecting performance of the inkjet printhead. That is, when about 50% of all the pores per nozzle were open, shortage in ink supply did not occur.

From the results of the above experiments, it can be said that during the service life of the inkjet printhead as a product, 41 of all the pores per nozzle will be closed or clogged with foreign particles, and a sufficient amount of the black ink will be supplied to the nozzles 11a when at least 68 of all the pores (i.e., 136 pores) per nozzle are open or are not be clogged with foreign particles. Hence, the number of the pores per nozzle, i e., n/N, should be at least 110 that is a minimum integer larger than a sum of 68 and 41, in order that the inkjet printhead 1 sufficiently excellently functions as a product. Thus, the following condition should be satisfied:
n/N≧110 (2)

Thus, the filtering portion 51d employed in the experiments, where the number of the pores 53 per nozzle, i.e., n/N, is set at 136, meets a requirement with respect to capability of the inkjet printhead as a product, with a margin.

The relational expression (2), that is, n/N≧110, which is obtained through the experiments, is applicable to the other filtering portions 51a-51c for the other inks. For instance, the number N of the nozzles 11a of the nozzle group for each of the cyan, yellow and magenta inks is 74, and smaller than that of the nozzles 11a of the nozzle group for the black ink. Where 74 is substituted for N in the expression (2), it is found that the number n of the pores 53 of the filtering portion 51a-51c for each of the cyan, yellow and magenta inks should be 8140 (=74×110) or more. By using the expression (2) in this way, even when the number N of nozzles 11a of a nozzle group is changed due to design change or for other reasons, the number n of pores 53 necessary in the corresponding filtering portion 51 can be easily determined.

The filter member 50 is formed by electroforming that is, a metal is deposited on an exposed part of the base form 54 to form the filter member 50. Depending on an area of the exposed part of the base form 54, a speed at which the deposition progresses varies. Meanwhile, the filter member 50 includes the frame 52 continuously extending in a relatively large area, and the filtering portions 51 each having pores 53, each of which has a small diameter, and each adjacent two of which are separated from, or connected to, each other by a part of the metal film forming the film member 50. Hence, the shape of the pores 53 is affected by a ratio of an area of the frame 52 as seen in plan view of FIG. 4A to an entire area of the filter member 50 in the same plan view. Thus, the present applicant carried out an experiment to form the filter members 50 with the ratio of the area of the frame 52 to the entire area of the filter member 50 variously changed, and found that when the area of the frame 52 was 70% or less of the entire area of the filter member 50, the pores 53 were formed in a desired shape with reliability, and the yield of the filter members 50 was improved.

As shown in FIG. 4B, the filter member 50 is produced such that a metal film to be the filter member 50 is formed on the base form 54, and separated from the base form 54. When the filter member 50 does not smoothly separate from the base form 54, the filter member 50 becomes a defective piece as a product. Hence, the applicant conducted a study to optimize a shape of the filter member 50 in respect of the easiness in the separation of the filter member 50 from the base form 54.

When the metal film to be the filter member 50 is separated from the base form 54, an entirety of the base form 54 is initially warped or deformed to gradually separate or peel the metal film from an end portion thereof. That is, upon deformation or warping of the base form 54, an end portion of the metal film does not follow or conform to the warping of the base form 54 and separates from the base form 54. The separation of the metal film from the base form 54 begins at the thus separated end portion, and thus becomes easier when the end portion of the metal film quickly gets off the base form 54.

Hence, the applicant carried out an experiment to form the filter members 50 with a ratio of a dimension W of shorter sides of the filter member 50 (shown in FIG. 4A) to a thickness t of the filter member 50 (shown in FIG. 4B) variously changed. The result of the experiment revealed that when the ratio W/t was not smaller than 293, i.e., W/t≧293, the easiness of separation of the film member 50 from the base form 54 was stably high to improve the yield of the filter members 50.

As described above, according to the embodiment, the nominal pore diameter d optimum for the nominal nozzle diameter D can be easily obtained by simply substituting the nominal nozzle diameter determined from the various conditions related to the inkjet printhead 1, for the variable D in the expression (1). Hence, even where the nominal nozzle diameter D is not uniform among a plurality of nozzle groups in a single inkjet printhead, such that the nozzles belonging to the nozzle group for the black ink have a diameter larger than that of the nozzles belonging to the nozzle groups for the other color inks, the pore diameters of the respective filtering portions 51 are determined to be suitable for the nominal nozzle diameters D of the respectively corresponding nozzle groups, so that all the nozzle groups can be quickly supplied with the ink and do not suffer from clogging. Thus, even where the nominal nozzle diameter D is varied among a plurality of nozzle groups depending on the volume of a single ink droplet ejected from the nozzles, the ejection characteristics are uniformly excellent among all the nozzle groups.

In addition to that the nominal pore diameter d is determined depending on the nominal nozzle diameter D, the number of the pores 53 of a filtering portion 51 is determined to increase with the number of the nozzles of a nozzle group to which the filtering portion 51 corresponds. Hence, the conventionally encountered problems of insufficient filtering effect and ink supply shortage are solved. Further, since the number N of the pores 53 can be easily determined using the expression (2), the clogging at nozzles and the ink supply shortage are further reliably prevented.

The filter member 50 is formed by electroforming, according to which a pattern of an insulating film is formed on a base form by photolithography, and then a metal is deposited on an area on a surface of the base form where the insulating film is not present. Hence, the shape of the filter member and the number and the diameter of pores in each of the filtering portions can be easily changed by simply changing the pattern of the insulating film. Accordingly, it is easy to form the filter member 50 in which a plurality of filtering portions 51 are integrally formed, and in which the diameter of the pores 53 is differentiated among the filtering portions 51. Thus, the production process of the inkjet printhead 1 can be simplified.

Further, by properly setting the ratio of the area of the frame 52 to the entire area of the film member 50 as well as the shape of the filter member 50, as described above, the filter member 50 can be stably produced, enhancing the yield of the filter members 50. More specifically, the filter member 50 includes the frame 52 where the metal film having substantially no pores continuously extends in a relatively wide area, and the filtering portions 51 in each of which small pores are arranged in the metal film with thin or narrow parts of the metal film being present between the small pores. In such a filter member 50, the area of the frame as seen in plan view of FIG. 4A is made relatively small, namely, 70% or smaller of the entire area of the film member 50 in the same plan view, thereby enabling to stably form the pores 53 of the filtering portions 51 in the desired dimensions. That is, in electroforming, the state of deposition of a metal varies depending on the area over which the metal is to be deposited, which may cause problems such as a non-uniform thickness of a film formed of the metal. Hence, a ratio of the area of the frame 52, which is the area where the metal is deposited over a relatively large area, to the entire area of the filter member 50, is reduced to stably form in desired dimensions the filtering portions in each of which the metal is deposited to form or define the pores 53, so as to enhance the yield of the filter members 50.

Although in the above-described embodiment the diameter of the nozzles of the nozzle group for the black ink is set to be larger than that of the nozzles of the nozzle groups for the other color inks, this is not essential. The diameter of the nozzles of the nozzle groups for the color inks other than the black ink may be set at a larger value than that of the nozzle group for the black ink, as needed.

Although there has been described one presently preferred embodiment of the invention, it is to be understood that the invention is not limited to the details of the above-described embodiment, but may be otherwise embodied with various modifications and improvements that may occur to those skilled in the art, without departing from the scope and spirit of the invention defined in the appended claims.

For instance, the shape of the pores in the filtering portion is not limited to a circular shape, but may be a polygonal shape. In particular, where hexagonal pores are arranged in a honeycomb-like manner in a filtering portion 51, the number of pores formable per unit area can be increased compared to the case where the pores have other polygonal shapes or a circular shape. This is effective to reduce the adverse influence of clogging of the pores with foreign particles, which increases the resistance to the flow of the ink.

It may be arranged such that during the production process of the filter member 50, information in the form of text, symbols, or others, related to the base form 54 or the insulating film is put on the frame 52.

The liquid-droplet ejecting apparatus to which the invention is applied is not limited to inkjet printheads. For instance, the liquid-droplet ejecting apparatus may take the form of a pipetter for ejecting a droplet of a liquid, such as chemical, with high precision. In particular, the invention is suitably applicable to a case where a plurality of chemicals having respective properties are supplied as liquids to be ejected, to a liquid-droplet ejecting apparatus, and the nozzle diameter is differentiated among nozzle groups corresponding to the respective chemicals, depending on the difference among the chemicals in viscosity or in volume of a single droplet to be ejected.

What is claimed is:

1. A liquid-droplet ejecting apparatus comprising:
a cavity unit having a plurality of nozzle groups each of which includes at least one nozzle from which a droplet of a liquid is ejected, at least two of the nozzle groups being differentiated from each other in the cross-sectional area of the nozzles;
a supply-passage forming portion which integrally includes a plurality of liquid supply passages corresponding to the respective nozzle groups, the liquid supply passages being open in a same surface of the supply-passage forming portion;
a filter member which integrally includes a plurality of filtering portions and is closely attached to the surface of the supply-passage forming portion such that the filtering portions respectively cover openings of the liquid supply passages, each of the filtering portions having a plurality of pores of a cross-sectional area such that a cross-sectional area of pores in one of the filtering portions, which corresponds to a first one of the at least two nozzle groups a cross-sectional area of the nozzle belonging to which is larger than that of the nozzle belonging to a second one of the at least two nozzle groups, is larger than a cross-sectional area of pores of another filtering portion corresponding to the second nozzle group.

2. The apparatus according to claim 1, wherein the liquid supply passages are open in an outer surface of the cavity unit, and the filter member is fixed to the outer surface as the same surface.

3. The apparatus according to claim 1,
wherein each nozzle and each filtering pore are circular in cross section,
and wherein where a nominal value of a diameter of the nozzle belonging to each of the nozzle groups is represented by D, a nominal value of a diameter of each of the pores of one of the filtering portions which corresponds to the nozzle group is represented by d, a dimensional tolerance of the nozzle is represented by ±α, a dimensional tolerance of the pores is represented by ±β, and a maximum diameter of a foreign particle capable of passing through the pores having the nominal diameter d is represented by d+γ, D and d satisfy the following condition:
D−(α+β+γ)≧d.

4. The apparatus according to claim 1, further comprising a plurality of actuator groups, each of which includes at least one actuator which operates to eject a droplet of a liquid from at least one nozzle of a corresponding one of the nozzle groups, an actuator belonging to one of the actuator groups, which corresponds to the first nozzle group the cross-sectional area of the nozzle belonging to which is larger than that of the nozzle belonging to the second nozzle group, operates to eject a liquid droplet larger in volume than a liquid droplet ejected by operation of the actuator belonging to another actuator group corresponding to the second nozzle group.

5. The apparatus according to claim 1, wherein the number of pores of one of the filtering portions, which corresponds to a third one of the at least two nozzle groups the number of nozzle or nozzles belonging to which is larger than the number of nozzle or nozzles belonging to a fourth one of the at least two nozzle groups, is larger than the number of pores of another filtering portion corresponding to the fourth nozzle group, where each of the third nozzle group and the fourth nozzle group can be the first nozzle group or the second nozzle group.

6. The apparatus according to claim 1, wherein the number N of pores in one of the filtering portions, and the number n of nozzle or nozzles belonging to one of the nozzle groups which corresponds to the one filtering portion, satisfy the following condition:
n/N≧110.

7. The apparatus according to claim 1, wherein the filter member further includes an integrally formed frame which connects the filtering portions such that the filtering portions are discontinuous from one another.

8. The apparatus according to claim 7, wherein the filtering portions are arranged in a line inside the frame.

9. The apparatus according to claim 1, wherein the filter member is formed of metal.

10. The apparatus according to claim 9, wherein the filter member is a sheet-like member formed by electroforming.

11. The apparatus according to claim 10, wherein the filter member has an elongate shape having a width W and a thickness t that satisfy the following condition:
W/t≧293.

12. The apparatus according to claim 1, wherein the filter member further includes an integrally formed frame which connects the filtering portions such that the filtering portions are discontinuous from one another, the filter member being formed by electroforming.

13. The apparatus according to claim 12, wherein an area of the frame does not exceed 70% of an entire area of the filter member.

14. The apparatus according to claim 1, wherein the filter member is a sheet-like member formed by Lithographie Galvanoformung und Abformung.

15. The apparatus according to claim 1, wherein a plurality of nozzles belong to each of the nozzle groups.

16. The apparatus according to claim 15, wherein a plurality of nozzle rows, each of which is formed by nozzles belonging to one of the nozzle groups, extend parallel to one another in a surface of the cavity unit, and each nozzle is for ejecting a droplet of an ink as the liquid.

17. The apparatus according to claim 16, wherein one of the nozzle rows is for ejecting a droplet of a black ink, and at least one other nozzle row is for ejecting a droplet of an ink of a color other than black, a cross-sectional area of the nozzles belonging to the nozzle row for ejecting the droplet of the black ink being larger than that of the nozzles belonging to the at least one other nozzle row for ejecting the droplet of the ink of the color other than black.
